(19) United States
(12) Patent Application Publication
(10) Pub. No.: US 2005/0280770 A1
(43) Pub. Date: Dec. 22, 2005

(54) Auxiliary lens for double-tier eyeglasses

(75) Inventor: Gao Yong, Wen Zhou City (CN)

Correspondence Address: LAW OFFICES OF CLEMENT CHENG, 17220 NEWHOPE STREET #127, FOUNTAIN VALLEY, CA, 92708, US

(73) Assignee: Wenzhou Jingmei Optical Co., Ltd.

(21) Appl. No.: 11/154,992

(22) Filed: Jun. 16, 2005

(30) Foreign Application Priority Data
Jun. 16, 2004 (CN) 200420066040.8

(51) Int. Cl. G02C 9/00

(52) U.S. Cl. 351/47

(57) ABSTRACT

Universal auxiliary lens to be used with a bottom glasses are provided. The auxiliary lens consists of a pair of preventive lenses having a bridge and clips interposed therebetween. The protective lens pairs are fixed to the two ends of the bridge with two or more fasteners; the clips are affixed to the bridge and inserted behind the bridge of the bottom glasses of the double-tier eyeglasses to hold the auxiliary lens in place while the end of each clip is a grappling claw which is in the shape of a hook.

### FIELD OF INVENTION

This invention relates to double-tier eyeglasses; it particularly relates to the auxiliary glasses or lens that attach to double-tier eyeglasses.

### DISCUSSION OF RELATED ART

The double-tier eyeglasses that are currently available on the market consist of the primary lens that are regular glasses and the auxiliary lens. For some of them, the double-tier eyeglasses, the primary lens and auxiliary lens are secured to each other with magnets. Unfortunately, magnets must be fitted in corresponding positions on the primary lens and auxiliary UV protective lens. For others, the two are secured together with screws or clips on the sides of the bottom glasses. As a result, the auxiliary lens could only be used on specialized primary lens and they therefore lack universal applicability and become inconvenient to use.

To remedy the shortcomings of the prior art, this invention provides one kind of auxiliary lens with clips, which are more convenient to use and more compatible with all kinds of eyeglasses.

### SUMMARY OF THE INVENTION

To achieve the above objective, this invention uses a clip technique. The auxiliary lens of the double-tier glasses consist of a bridge, protective lenses, and clips. The primary lenses are fixed to the two ends of the bridge. The clips are affixed to the bridge. The clips are placed over the bridge of the primary lens being the bottom glasses of the double-tier glasses. The clips hold the auxiliary lens in place and at one end of each of the clips is a hook-shaped grappling claw.

The advantages that this invention offers above those of the prior art are: This invention has strong universal applicability and its installation is quick and easy.

### BRIEF DESCRIPTION OF THE DRAWINGS

FIG. 1 is an auxiliary lens showing the connection side that connects to bottom glasses.

FIG. 2 is an auxiliary lens showing the front side.

FIG. 3 is a perspective view of the assembled invention.

FIG. 4 shows a top perspective view showing assembly of the auxiliary lens to the primary lens and having enlarged perspective views of the structure of the connecting area where grappling claws hang onto the frame of the bottom glasses.

FIG. 5 shows a top perspective view showing assembly of the auxiliary lens to the primary lens and having enlarged perspective views of the structure of the connecting area where grappling claws grasp lenses of the bottom glasses.

FIG. 6 shows a top perspective view showing assembly of the auxiliary lens to the primary lens and having enlarged perspective views of the structure of the connecting area where grappling claws grasp the stub of the nosepieces.

FIG. 7 shows a top perspective view showing assembly of the auxiliary lens to the primary lens and having enlarged perspective views of the structure of the connecting area where grappling claws grasp the bridge of the bottom glasses.

FIG. 8 is an alternative embodiment assembly of the auxiliary lens to the primary lens and having enlarged perspective views of the structure of the connecting area

FIG. 9 is an alternative embodiment auxiliary lens bridge piece showing the connection side that connects to bottom glasses.

FIG. 10 is an alternative embodiment auxiliary lens showing the connection side that connects to bottom glasses.

### DETAILED DESCRIPTION OF THE PREFERRED EMBODIMENT

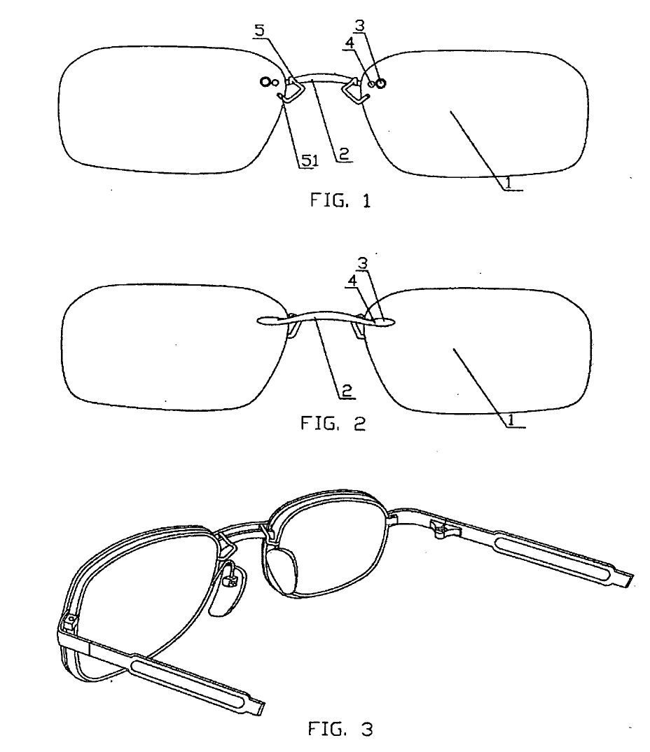

The primary embodiment has grappling claws 51 that allow a user to connect auxiliary lenses to complement the primary lenses on the bottom glasses. The actual implementation of this invention is described with the aid of drawings. FIG. 1 is a perspective view of the structure from the connection side that connects between this invention and the primary lens. FIG. 2 shows the front side. FIG. 3 shows the assembled invention. The auxiliary lens consists of protective lenses 1, a bridge, 2, and clips 5. The protective lenses are affixed to the two ends of the bridge with two or more fasteners. In this example, the two are joined together with rivets 3 and raised points 4. The rivets 3 join together the bridge 2 and the protective lenses 1. The raised points 4 are located on the bridge 2. At a corresponding location on each protective lens 1 is created a small hole. At the time of assembly, the raised points 4 are fitted into the small holes to prevent the protective lenses 1 from turning around the rivets. The cross-section of the raised point 4 can be round, rectangular, angular, or, of any plane shape. Screws may be used in place of rivets 3 to hold the two together. The connection between the clip 5 and the bridge 2 may be fixed, such as by soldering. The connection may also be movable, such as affixing the clip 5 to the bridge with a hinged joint. At one end of each of the clips 5 is a grappling claw 51, which is in the shape of a hook.

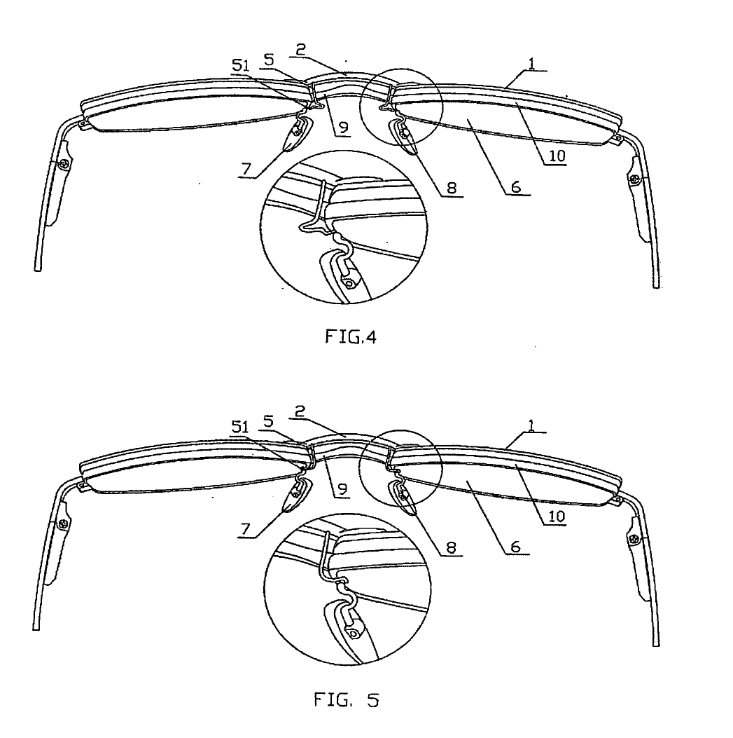

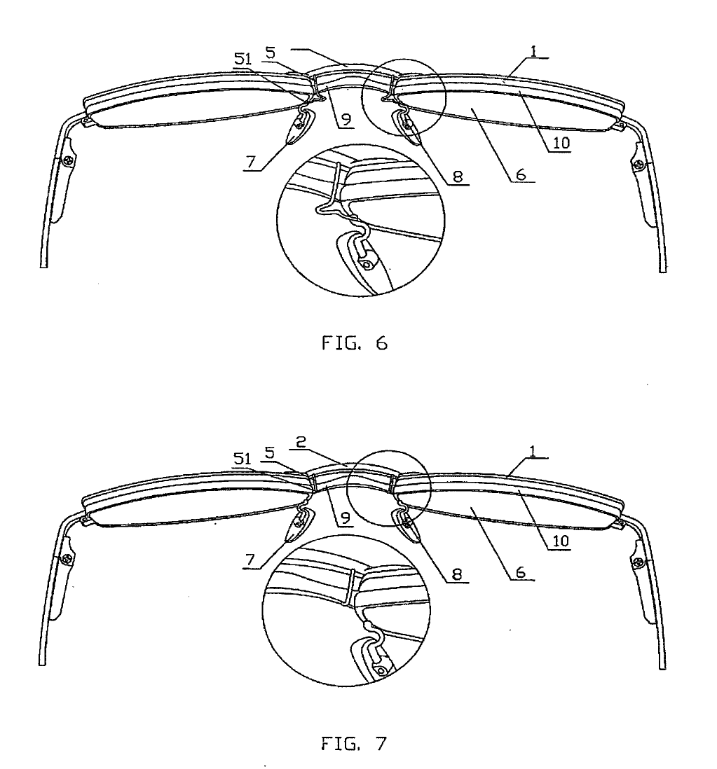

The grappling claws 51 may be covered with a layer of soft protective coating. When used, as shown in FIG. 4, the clips 5 of the auxiliary lens are inserted behind the bridge 9 of the bottom glasses so that the grappling claws 51 hang onto the frame 10 of the bottom glasses; the entire set of auxiliary lens is on the front side of the bottom glasses. By adjusting the direction and size of the grappling claws 51, the grappling claws 51 could also grasp the lenses of the bottom glasses, as seen in FIG. 5, or the stub 8 of the nose pieces 7, as seen in FIG. 6, or, the bridge 9 of the bottom glasses, as seen FIG. 7.

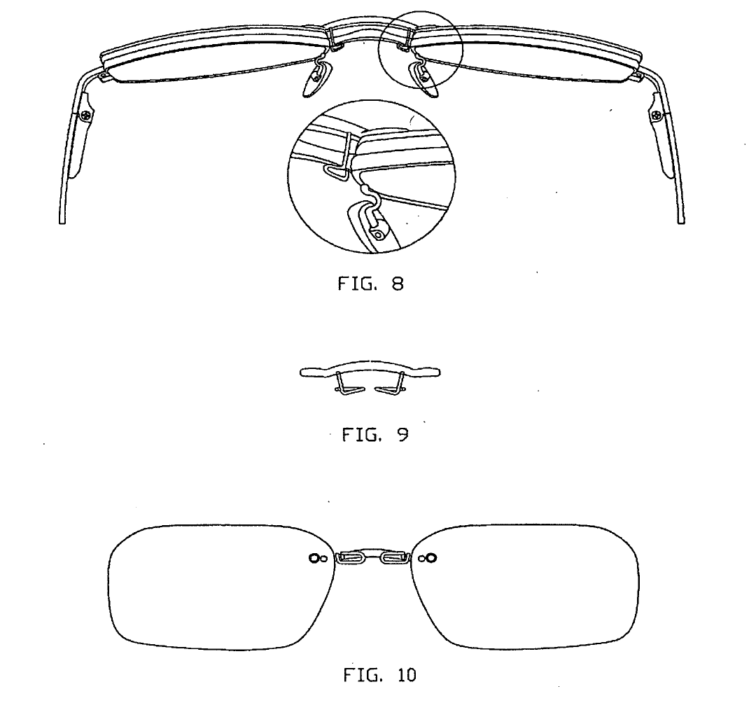

FIG. 8-10 shows an alternative embodiment with top, enlarged and connection side view. The alternative embodiment new hangs as seen in the schematic drawings. The connection between the clip 5 and the bridge 2 uses symmetrical grappling claws 51 forming basically parallel approximately rectangular profiles. The grappling claws 51 begin from the cross bridge member shown in FIG. 9 and form a rectangular wire frame profile terminating up ward. The alternative embodiment grappling claws allow a user to connect the auxiliary lenses to the primary lenses on the bottom glasses.

The foregoing describes the preferred embodiments of the invention and modifications may be made without departing from the spirit and scope of the invention as set forth in the following claims.

1. Auxiliary lens for use with eyeglasses having bottom glasses comprising:
a. a pair of protective lenses, having a bridge, and
b. clips interposed therebetween; wherein the protective lenses are fixed to the two ends of the bridge; wherein the clips are affixed to the bridge and inserted behind the bridge of the bottom glasses of the double-tier eyeglasses to hold the auxiliary lens in place; and the end of each clip being a grappling claw which is in the shape of a hook.

2. The auxiliary lens of claim 1, wherein the positions and size of the grappling claws may be adjusted so that the grappling claws could grasp the lenses of the bottom glasses, or, the stub of the nose pieces, or, the bridge of the bottom glasses.

3. The auxiliary lens of claim 2, wherein the grappling claws (51) are covered with a layer of soft protective coat.

4. The auxiliary lens of claim 2, wherein the protective lenses (1) are housed in a frame; the frame could be a full frame, or, it could be half frame covering either the top half or the bottom half of the lenses.

5. The auxiliary lens of claim 1, wherein the protective lenses (1) are affixed to the bridge (2) with two or more fasteners.

6. The auxiliary lens of claim 2, wherein the positions and size of the grappling claws may be adjusted so that the grappling claws could grasp the lenses of the bottom glasses, or, the stub of the nose pieces, or, the bridge of the bottom glasses.

7. The auxiliary lens of claim 2, wherein the fastener could be a rivet or a screw, the other fastener being a raised point.

8. The auxiliary lens of claim 7, wherein the positions and size of the grappling claws may be adjusted so that the grappling claws could grasp the lenses of the bottom glasses, or, the stub of the nose pieces, or, the bridge of the bottom glasses.

9. The auxiliary lens of claim 7, wherein the raised point is set into the protective lens (1):

10. The auxiliary lens of claim 9, wherein the positions and size of the grappling claws may be adjusted so that the grappling claws could grasp the lenses of the bottom glasses, or, the stub of the nose pieces, or, the bridge of the bottom glasses.

11. The auxiliary lens of claim 1, wherein the connection between the clips and the bridge may be fixed or movable.

12. The auxiliary lens of claim 11, wherein the positions and size of the grappling claws may be adjusted so that the grappling claws could grasp the lenses of the bottom glasses, or, the stub of the nose pieces, or, the bridge of the bottom glasses.

13. The auxiliary lens of claim 11, wherein the connection is fixed by soldering.

14. The auxiliary lens of claim 13, wherein the positions and size of the grappling claws may be adjusted so that the grappling claws could grasp the lenses of the bottom glasses, or, the stub of the nose pieces, or, the bridge of the bottom glasses.

15. The auxiliary lens of claim 11, wherein the movable connection is made between the clips and bridge with a hinged joint.

16. The auxiliary lens of claim 15, wherein the positions and size of the grappling claws may be adjusted so that the grappling claws could grasp the lenses of the bottom glasses, or, the stub of the nose pieces, or, the bridge of the bottom glasses.

17. Auxiliary lens for use with eyeglasses that have a bridge comprising:
a. a pair of protective lenses, having an auxiliary bridge;
b. two clips interposed between the pair of protective lenses; wherein the protective lenses are fixed to the two ends of the auxiliary bridge; wherein the clips are affixed to the auxiliary bridge and shaped to be inserted behind an eyeglass bridge to hold the auxiliary lens in place; and
c. symmetrical grappling claws formed on the ends of the clips each forming a rectangular wire frame profile, whereby allowing a user to connect the auxiliary lenses to the primary lenses on the bottom glasses.
